(19) United States
(12) Patent Application Publication
(10) Pub. No.: US 2005/0262970 A1
(43) Pub. Date: Dec. 1, 2005

(54) Reinforcement teeth for ratchet tools

(76) Inventor: Chih-Ching Hsien, Feng Yuan (TW)

Correspondence Address: Mr. Phillip Liu, 6980, Whiteoak Dr., Richmond, BC, V7E 4Z9, CA

(21) Appl. No.: 10/854,205

(22) Filed: May 27, 2004

(51) Int. Cl. B25B 13/46

(52) U.S. Cl. 81/63.2

(57) ABSTRACT

A ratchet tool includes an engaging wheel rotatably received in a through hole of a head and being in contact with a pawl which is controlled by a control member. The engaging wheel includes first teeth defined in an outer periphery thereof and the pawl includes second teeth which are engaged with the first teeth. The first teeth each have a peak portion and a root portion. The peak portion includes a first reinforcement surface connected between two sides of the first teeth, and the root portion includes a second reinforcement surface connected between respective one of the two sides of the two first teeth between which the root portion is located. The reinforcement surfaces reduce wearing of the first and second teeth and increase the structural strength of the first and second teeth.

### FIELD OF THE INVENTION

The present invention relates to reinforcement teeth of the engaging wheel for ratchet tools and each of the teeth on the engaging wheel includes a dulled peak portion and a root portion.

### BACKGROUND OF THE INVENTION

An improvement to the conventional ratchet tools known to the applicant is disclosed in U.S. Pat. No. 6,662,687. The disclosure in FIG. 4 of U.S. Pat. No. 6,662,687 employs sharp angled tooth peak and root. Further referring to FIGS. 8 and 9, each tooth having a sharp peak portion such disclosed in the application of U.S. Pat. No. 6,662,687 tends to be worn out and the debris 50 due to the wearing of the teeth could be accumulated in the root portions of the teeth. The accumulation accelerates the wearing of the teeth and increases the gap between the teeth of the pawl and the engaging wheel. The conventional profile of the teeth used in the ratchet tools is needed to be improved.

The present invention intends to provide reinforcement teeth used in the engaging wheel of ratchet tools and the peak portion and the root portion of each tooth are dulled so as to reduce wearing and prevent from being broken.

### SUMMARY OF THE INVENTION

The present invention relates to a ratchet tool that comprises a head with a through hole and an engaging wheel is rotatably received in the through hole and in contact with a pawl received in a side hole defined in an inner periphery of the through hole. The pawl is controlled by a control member rotatably inserted in a passage defined in the head. The engaging wheel includes first teeth which are engaged with second teeth defined in a side of the pawl. The first teeth each have a peak portion and a root portion. The peak portion includes a first reinforcement surface connected between two sides of the first teeth, and the root portion includes a second reinforcement surface connected between respective one of the two sides of the two first teeth between which the root portion is located.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the ratchet tool of the present invention;

FIG. 2 is a perspective view of the first teeth of the engaging wheel;

FIG. 3 is a cross sectional view of the ratchet tool of the present invention;

FIG. 4 is an enlarged view to show the engagement of the first and second teeth of the ratchet tool;

FIG. 5 shows the detail formation of the first teeth;

FIG. 6 shows a second embodiment of the first reinforcement surface;

FIG. 7 shows a third embodiment of the first reinforcement surface;

FIG. 8 is a cross sectional view of a conventional ratchet tool, and

FIG. 9 is an enlarged view to show the engagement of the teeth of the pawl and the engaging wheel of the conventional ratchet tool.

### DETAILED DESCRIPTION OF THE PREFERRED EMBODIMENT

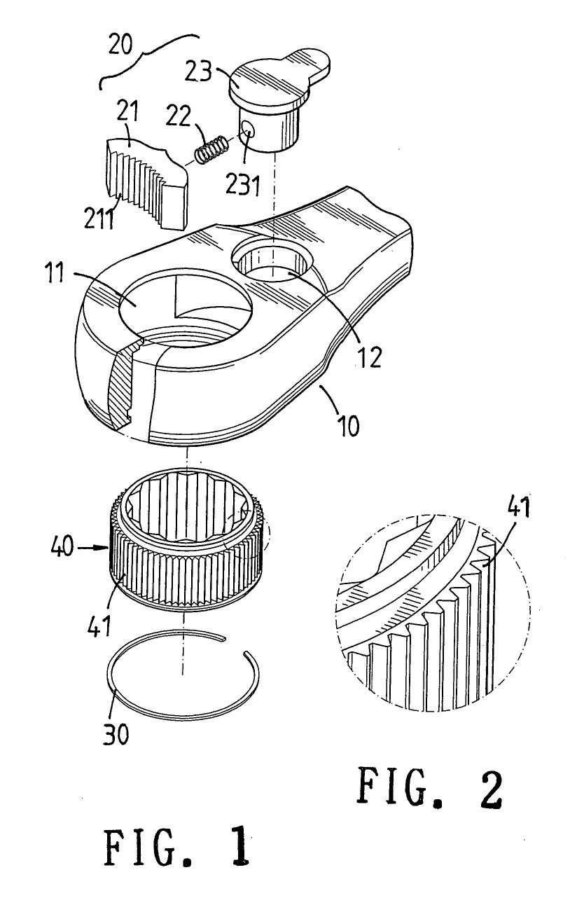

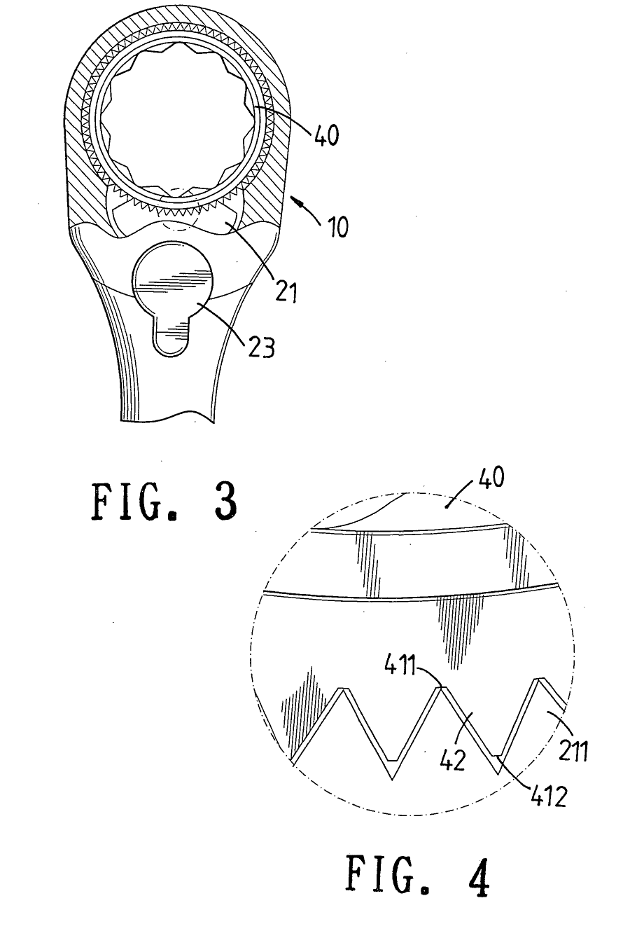

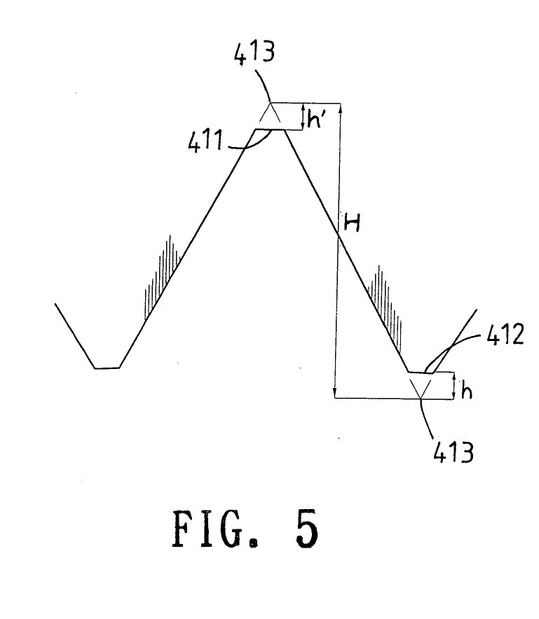

Referring to FIGS. 1 to 4, the ratchet tool of the present invention comprises a head 10 having a through hole 11 defined therein and an engaging wheel 40 is rotatably received in the through hole 11. A side hole is defined in an inner periphery of the through hole 11 and a pawl 21 of a ratchet mechanism 20 is movably received in the side hole. The engaging wheel 40 includes first teeth 41 defined in an outer periphery thereof and a polygonal inner periphery which is sued to mounted to an object such as a nut. The pawl 21 includes second teeth 211 defined in a side thereof so as to be engaged with the first teeth 41. A control member 23 is rotatably inserted in a passage 12 defined in the head 10 and has a receiving hole 231 defined therein. A spring 22 has one end thereof received in the receiving hole 231 and the other end of the spring 22 engaged with a second side of the pawl 21. When rotating the control member 23, the spring 22 pushes the pawl 21 to make either one of two end portions of the pawl 21 move toward the engaging wheel 40.

Referring to FIG. 5, the first teeth 41 each have a peak portion and a root portion. The root portion includes a first reinforcement surface 411 connected between two sides of the first teeth 41, and the peal portion includes a second reinforcement surface 412 connected between respective one of the two sides of the two first teeth 41 between which the peak portion is located. The formation of the first reinforcement surface 411 is defined by the following definition wherein two extension lines extending from the two sides that connect the first reinforcement surface 411 of the root portion intersects at a first intersection point 413 and two extension lines extending from the two sides that connect the second reinforcement surface 412 of the peak portion intersects a second intersection point 413. A distance “h” between the first intersection point 413 and the first reinforcement surface 411 of the root portion is 1/20 to 3/20 of a distance “H” in a normal direction of the engaging wheel 40 between the first intersection point 413 and the second first intersection point 413.

Similarly, the formation of the second reinforcement surface 412 is defined by the following definition wherein a distance “h” between the second intersection point 413 and the second reinforcement surface 412 of the peak portion is 1/20 to 3/20 of the distance “H” as defined above. The definition of the formation of the first and second reinforcement surfaces 411, 412 is the optimized design which makes the first teeth 41 have good structural strength and be durable from wearing.

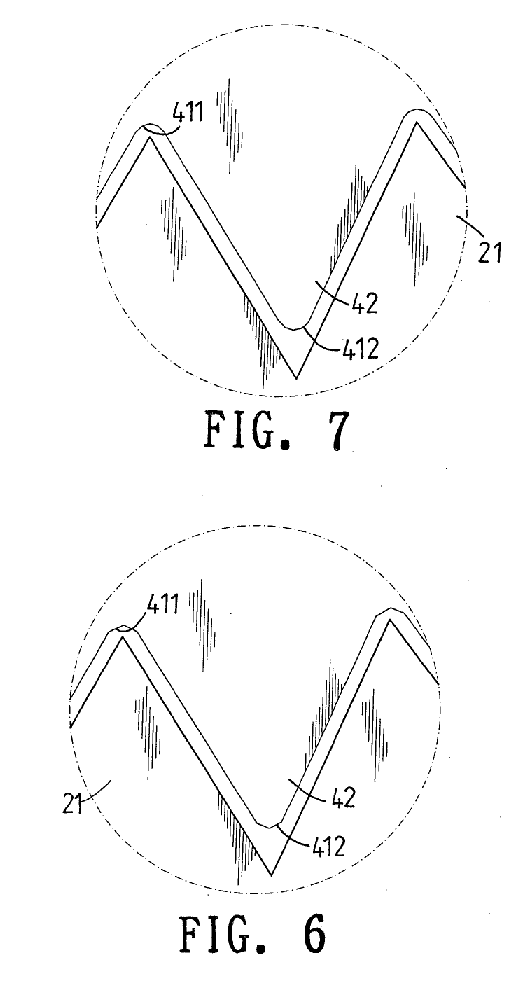

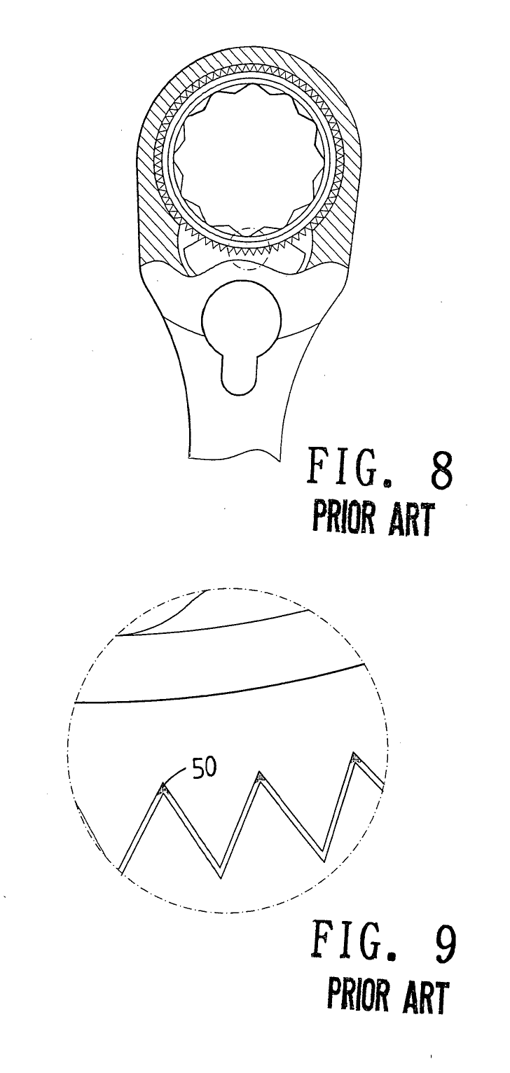

Referring to FIGS. 6 and 7, each of the first and second reinforcement surfaces 411, 412 includes a multi-surface at different angles such as two surfaces as disclosed in FIG. 6 and four surface as disclosed in FIG. 7.

While we have shown and described the embodiment in accordance with the present invention, it should be clear to those skilled in the art that further embodiments may be made without departing from the scope of the present invention.

1. A ratchet tool comprising:
a head with a through hole defined therein and an engaging wheel rotatably received in the through hole, a side hole defined in an inner periphery of the through hole and a pawl movably received in the side hole, the engaging wheel including first teeth defined in an outer periphery thereof and the pawl including second teeth defined in a side thereof, the second teeth engaged with the first teeth, a control member rotatably inserted in a passage defined in the head and having a receiving hole defined therein, a spring having one end thereof received in the receiving hole and the other end of the spring having engaged with a second side of the pawl, the first teeth each having a peak portion and a root portion, the peak portion including a first reinforcement surface connected between two sides of the first teeth, the root portion including a second reinforcement surface connected between respective one of the two sides of the two first teeth between which the root portion is located.

2. The ratchet tool as claimed in claim 1, wherein each of the first and second reinforcement surfaces includes a multi-surface at different angles.

3. The ratchet tool as claimed in claim 1, wherein two extension lines extending from the two sides that connect the first reinforcement surface of the root portion intersects at a first intersection point and two extension lines extending from the two sides that connect the second reinforcement surface of the peak portion intersects a second intersection point, a distance between the first intersection point and the first reinforcement surface of the root portion being 1/20 to 3/20 of a distance at a normal direction of the engaging wheel 40 between the first intersection point and the second first intersection point.

4. The ratchet tool as claimed in claim 1, wherein two extension lines extending from the two sides that connect the first reinforcement surface of the root portion intersects at a first intersection point and two extension lines extending from the two sides that connect the second reinforcement surface of the peak portion intersects a second intersection point, a distance between the second intersection point and the second reinforcement surface of the peak portion being 1/20 to 3/20 of a distance in a normal direction of the engaging wheel between the first intersection point and the second first intersection point.
